(19) United States
(12) Patent Application Publication
(10) Pub. No.: US 2005/0190570 A1
(43) Pub. Date: Sep. 1, 2005

(54) Phosphorescent interior panel

(76) Inventor: David Martyn Roessler, Hazel Park, MI (US)

Correspondence Address: KATHRYN A MARRA;General Motors Corporation, Mail Code 482-C23-B21, Legal Staff, P.O. Box 300, Detroit, MI, 48265-3000, US

(21) Appl. No.: 10/788,930

(22) Filed: Feb. 27, 2004

(51) Int. Cl. B60Q 1/32; F21V 9/16

(52) U.S. Cl. 362/503; 362/84

(57) ABSTRACT

A phosphorescent interior panel for illuminating an interior compartment of a vehicle. The panel is comprised of a polymer matrix and a phosphorescent material that will glow for a period of time after exposure to external light without the use of additional power. The phosphorescent interior panel improves visibility inside the vehicle without increasing heat load within the vehicle. A roof assembly comprising a roof wall, a phosphorescent interior panel and a light transmitting component. The phosphorescent material of the panel scatters or diffuses incident light, thereby providing the spacious sensation of an open roof. Also disclosed is a method for providing light into an interior portion of a vehicle with the phosphorescent interior panel.

### BACKGROUND

The present disclosure relates to an interior panel, and more particularly, to an interior panel containing a phosphorescent material that can be energized without the use of an external power source.

It is known in the art of vehicle passenger compartments to provide a design and/or structure to the interior of the vehicle to enhance visibility and allow an appearance of spaciousness within the vehicle. The design and/or structure may include additional lighting within the interior of the vehicle. Lighting, while providing enhanced visibility and illumination for a spacious appearance, often depends upon vehicle power or an additional power source. Further, additional lighting within the vehicle may also increase heat load within the vehicle.

An interior panel having luminescent material may provide enhanced visibility without the use of vehicle power or an additional power source. Luminescent material is made to glow as a result of photoluminescence excitation. As incident light passes into the passenger compartment, the luminescent material may glow for a period of time after exposure to the light. However, many luminescent materials glow for a short period of time and low intensity relative to the light exposure making enhanced visibility and spacious appearance a limited benefit. Moreover, in the absence of external light, such as at night, typical luminescent panels have limited practicality. Radioluminescent materials may provide the desired visibility for an adequate time period, but such materials pose environmental concerns.

### BRIEF SUMMARY

Disclosed herein is an interior panel for a vehicle. The panel comprises a phosphorescent material and a polymer matrix.

In accordance with another embodiment, a vehicle roof assembly comprising a roof wall extending between an interior portion and an exterior portion of a vehicle; and an interior roof panel comprised of a phosphorescent material and a polymer matrix, the interior roof panel being in communication with an interior surface of the roof wall.

Also disclosed is a method of providing light into an interior compartment of a vehicle, comprising exposing a panel to an external light source, wherein the panel is comprised of a phosphorescent material and a polymer matrix; absorbing radiant energy from the external light source to excite electrons in the phosphorescent material; and emitting visible light from the phosphorescent material and into the interior of the vehicle upon exposure to the external light source or upon discontinuation of the external light source.

The above described and other features are exemplified by the following figures and detailed description.

### BRIEF DESCRIPTION OF THE DRAWINGS

Referring now to the figures, which are meant to be exemplary embodiments, and wherein the like elements are numbered alike.

FIG. 1 is a general perspective view of an interior panel in accordance with the present invention.

FIG. 2 is a cross-sectional view of an interior panel having phosphorescent coating in accordance with the present invention.

FIG. 3 is a simplified schematic of a roof assembly in accordance with the present invention.

### DETAILED DESCRIPTION OF THE PREFERRED EMBODIMENT

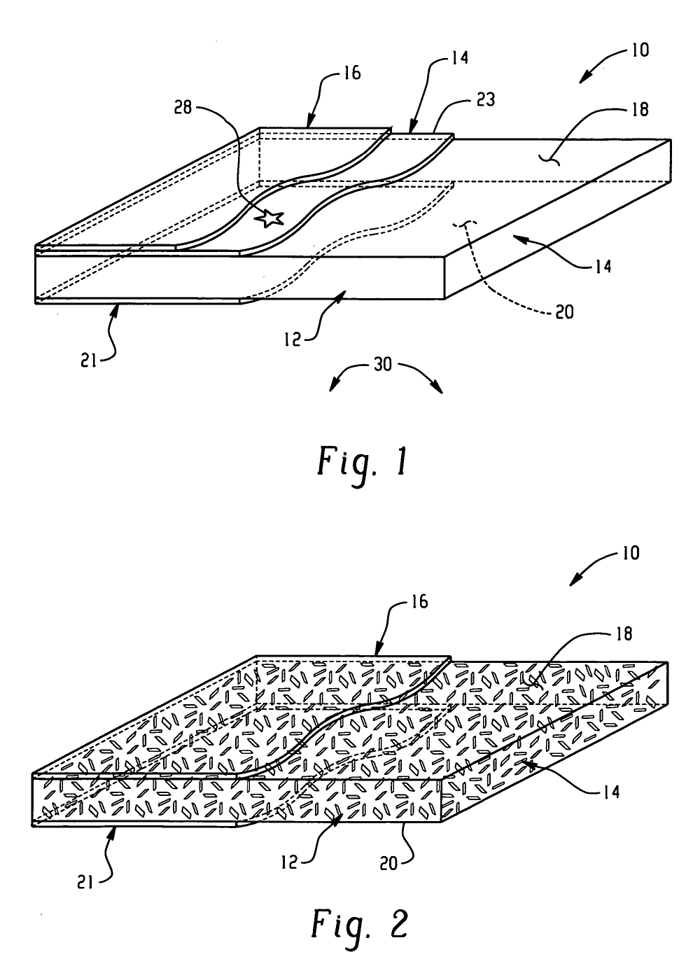

Referring now to FIG. 1, there is depicted an interior panel, generally designated as reference numeral 10, for a vehicle. In a preferred embodiment, the interior panel 10 is adapted to be attached to a vehicle roof. The interior panel 10 generally includes a polymer matrix 12 and a phosphorescent material 14. The phosphorescent material 14 may be dispersed within the polymer matrix 12 or located on a surface 18 of the polymer matrix 12. As the interior phosphorescent panel 10 is exposed to an external light source, the phosphorescent material 14 exhibits a glowing discharge for a period of time determined a decay of electrons in the excited state. The glowing discharge is preferably at wavelengths within the visible spectrum, i.e., wavelengths of about 350 nanometers (nm) to about 700 nanometers and provides a visible light source within the vehicle.

The polymer matrix 12 may comprise any of a variety of polymer compositions known to those skilled in the art, including plastic, thermosetting compositions, and/or thermoplastic compositions. The polymer matrix 12 preferably comprises a material capable of sustaining a predetermined shape while providing sufficient flexibility to function as an interior panel 10. Moreover, the polymer matrix 12, as well the phosphorescent material 14, should be suitable for use in the intended environment within a vehicle, i.e., attachment to a vehicle wall such as a roof. The selection of the type of polymer matrix 12 will be determined by the desired application and manufacturing process.

In a preferred embodiment, the polymer matrix 12 may transmit light having wavelengths of about 300 to about 750 nm, with about 400 to about 750 nm even more preferred. In a preferred embodiment, the polymer matrix 12 allows transmission of light within the absorption and emission spectrum of light. In this embodiment, the polymer matrix 12 may transmit radiant energy to the phosphorescent material 14 causing excitation of electrons of the phosphorescent material 14 as well as transmit light emitted by the phosphorescent material 14.

As the interior phosphorescent panel 10 is exposed to a light source, the phosphorescent material 14 located on a surface 18 of the polymer matrix 12 and/or disposed within the polymer matrix 12 is exposed to radiant energy from the light source. The phosphorescent material 14 absorbs a portion of the radiant energy from the light source causing excitation of electrons within the phosphorescent material 14. As the electrons fall back to their original energy levels, i.e., decay, energy is released in the form of visible light.

Suitable external light sources for exciting the phosphorescent material 14 include the sun, streetlights, headlamps, and the like. In addition to absorbing radiant energy from the external light source, the phosphorescent material. 14 may cause scattering of the light, thereby diffusing the light. In this manner, the phosphorescent material 14 may advantageously provide low level illumination even after cessation of exposure to the external light source. Advantageously, illumination occurs without the use of vehicle power and/or energy or increasing the heat load within the vehicle. Moreover, the illuminated interior panel 10 disposed on an interior surface of a wall of a vehicle may provide a feeling of spaciousness within the vehicle by providing light and a more open appearance. In one embodiment, the illuminated interior panel 10 may provide a feeling of spaciousness within the vehicle by providing a roof having an open appearance. As a result, the interior panel 10 may provide energy saving benefits by reducing the dependency on interior or supplemental vehicle lights to enhance passenger visibility as well as a comfortable, spacious sensation within the vehicle.

Upon excitation, the phosphorescent material 14 may emit light in the direction of the surfaces 18 and/or 20 to an area beyond the phosphorescent interior panel 10. As further shown in FIG. 1, the interior panel 10 may comprise light transparent material 16 and/or light reflective material 21.

As previously described and shown in FIG. 1, the phosphorescent material 14 may be dispersed within the polymer matrix 12. For example, the phosphorescent material 14 may be dispersed within a polymer matrix 12 that is employed during fabrication a plastic interior panel or is used as one of the layers in a laminate interior panel. In thermoplastic and/or thermosetting polymer matrices, the phosphorescent material 14 may be added directly to forming or heated thermoplastic and/or thermosetting material during fabrication thereof. The choice and type of polymer materials as well as processes of interior panel manufacture are known to those skilled in the art.

In another embodiment, shown in FIG. 1, the phosphorescent material 14 is applied on a surface 18 of the polymer matrix 12. In this embodiment, the phosphorescent material 14 may be cast in a suitable binder or in a solvent to form the layer. In yet another embodiment, also illustrated in FIG. 1, the phosphorescent material 14 may be dispersed within a polymer matrix 12 in combination with phosphorescent material 14 applied to a surface 18. The placement of the phosphorescent material 14 may be determined by the desired application.

The phosphorescent material 14 is chosen from materials known to those skilled in the art. Exemplary phosphorescent materials 14 include, but are not limited to, non-oxide phosphors such as zinc sulfide phosphors, which may become excited quickly to attain maximum brightness. Zinc sulfide phosphors generally exhibit a glow light discharge for shorter periods of time than other phosphors. A zinc sulfide composition may be doped with at least one transition metal or rare earth metal to enhance photoluminescence excitation. For example, zinc sulfide doped with copper metal, i.e., ZnS:Cu, may require only a few seconds of ultraviolet or incident light exposure to provide a glow light discharge. Other zinc sulfide phosphor compositions may be configured to provide a glow light discharge with a particular hue. For instance, zinc sulfide doped with silver metal, i.e., ZnS:Ag, may provide a blue glow light discharge. Zinc sulfide doped with manganese metal, i.e., ZnS:Mn, may provide a green glow light discharge. These and other zinc sulfide compositions are known to those skilled in the art to provide a glow light discharge in response to photoluminescence excitation.

Other phosphors include long decay time phosphors such as oxide phosphors including, but not limited to, oxide ceramic phosphors. As in the zinc sulfide compositions, oxide ceramic phosphors may be doped, such as with a rare earth metal. These types of phosphors generally exhibit a long decay time. For example, an alkaline-earth metal oxide aluminate material may have longer glow light discharge time after exposure to radiant energy of the appropriate wavelength. These phosphors may be exposed to light for longer periods of time to achieve excitation to provide a longer and brighter glow light discharge relative to non-oxide phosphors. A typical alkaline-earth oxide aluminate may provide a glow light discharge still visible after 24 hours. Suitable examples of non-oxide phosphors include, but are not intended to be limited to, strontium oxide aluminate doped with europium, strontium oxide aluminate doped with europium and dysprosium, and the like. Other suitable compositions are known to those skilled in the art, and the selection of type, amount, and location of the oxide phosphors is determined by the desired application.

In another embodiment, the phosphorescent material 14 contains more than one type of phosphor. One of the phosphors preferably comprises a phosphor having a long decay time such as the alkaline-earth oxide aluminate material described above, and at least one of the other phosphors preferably comprises a relatively shorter decay time, for example the zinc sulfide type phosphors. Less than an hour of daylight exposure may effectively excite the various phosphors comprising the phosphorescent material 14 to cause the phosphorescent material 14 to provide a continuous glow light discharge for many hours. The different types of phosphors may be combined in such a way that a predetermined pattern is visible when the phosphors are excited, as shown by the star pattern 28, in FIG. 1. In additional embodiments, phosphors may be combined as to type and amount to provide desired visibility or aesthetic patterns. Phosphors may be chosen as to type and concentration to produce a shading effect, distributing a glow to specific areas within the vehicle. The phosphorescent material 14 may be coated or dispersed within the polymer matrix 12 to provide a variety of configurations and glow hues as determined by the desired application.

Also shown in FIG. 1, the interior panel may comprise a light transparent material 16. In one embodiment, the light transparent material 16 can be applied to an exterior surface 23 of phosphorescent material 14.The light transparent material 16 preferably transmits light having wavelengths of about 200 to about 800 nanometers, with about 300 to about 750 nanometers more preferred and about 400 to about 750 nm most preferred. The light-transparent material 16 preferably allows transmission of light within the absorption and emission spectrum of light. In another embodiment, the light transparent material 16 comprises a durable material that allows for the transmission of light while functioning to protect the interior panel 10 from many of the hazards of use, i.e., scratches, tears, decomposition of materials. The selection and composition of the light-transparent material will be determined by the desired application.

The interior panel 10 may also optionally comprise a coating such as a layer and/or film of a reflective material 21, as shown in FIG. 1. A reflective material 21 may be applied to a surface 20 of the polymer matrix 12. As light travels through the interior panel 10 to the surface 20, the reflective material 21 may reflect the light back into the interior panel 10 and/or into the interior portion 30 of a vehicle. The composition of reflective material 21 are known to those skilled in the art, and selection of reflective material will be determined by the desired application.

As shown in FIG. 2, an interior panel 10 having phosphorescent material 14 dispersed throughout comprises a polymer matrix 12 and a phosphorescent material 14. As further shown, the interior panel may optionally comprise light-transparent material 16 which may be applied to a surface 18. As previously discussed, the light-transparent material 16 may protect the interior panel 10 while transmitting light. FIG. 2 also illustrates an interior panel 10 optionally comprising a reflective material 21 applied to a surface 20.

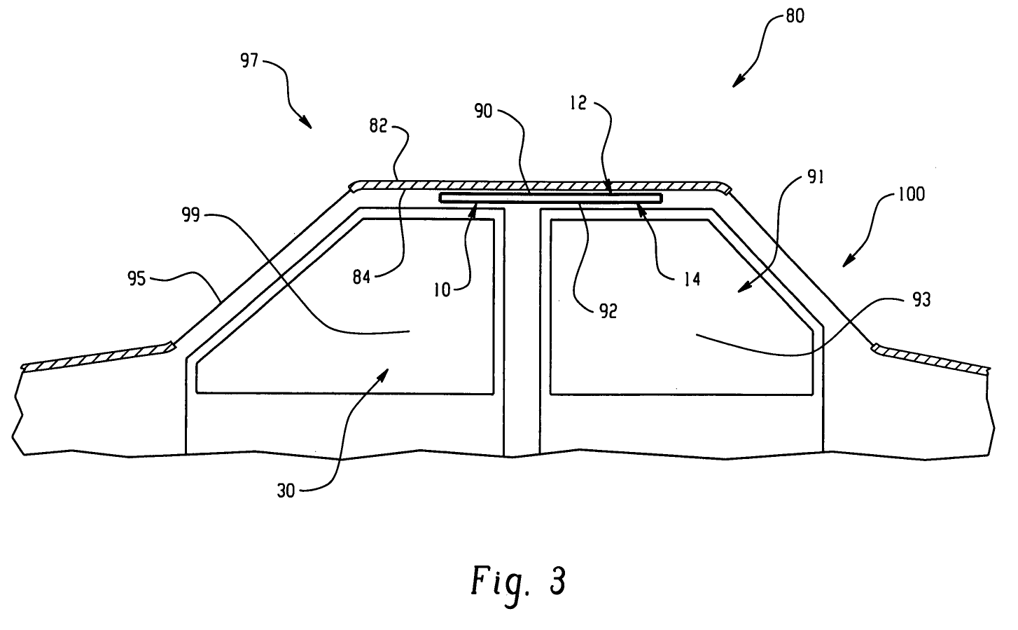

In FIG. 3, a simplified schematic of a roof assembly, generally designated as reference numeral 80, is shown. The roof assembly 80 includes a roof wall 82 extending between the exterior portion 97 and interior portion 30 of a vehicle 100 and an interior panel 10 disposed on an interior surface 84 of the roof wall 82. The interior panel 10 is generally comprised of a polymer matrix 12 and a phosphorescent material 14. A light conducting component 91 is disposed between a location external to the vehicle 100 and a point adjacent to the interior panel 10 to transmit external light to the interior panel 10 for exciting the phosphorescent material 14 to glow for a period of time following exposure to the external light.

The interior panel 10 may be of any of a variety of shapes such as circular, rectangular or other acceptable shape or dimension that provides adequate glow to achieve the desired illumination and enhanced visibility within the interior portion 30 of the vehicle 100. The interior panel 10 is preferably disposed on the interior surface 84 of the roof wall 82 by any method known in the art that provides the desired application of the roof assembly 80. The interior panel further comprises an interior surface 90 and an exterior surface 92. In one embodiment, an exterior surface 92 of the interior panel 10 is adjacent to the interior portion 30 of the vehicle 100. In an additional embodiment, the interior panel 10 may be disposed on an interior surface 84 of a roof wall 82 in a manner that provides an interior panel 10 that is movable, removable or generally attached to the interior surface 84 of the roof wall 82.

As further shown in this view, radiant energy from an external light source transmits through a light-conducting component 91 and onto an exterior surface 92 of the interior panel 10. The light-conducting component 91 may be comprised of glass, polymer, combination thereof, or any material capable of transmitting light. Suitable light transmitting components 91 are comprised of materials known to those skilled in the art and include glass, polymer compositions such as plastic, and combinations of glass and polymer compositions. The selection of material is determined by the desired application. The light-conducting material 16 preferably transmits light having wavelengths of about 200 to about 800 nm, with 300 to about 750 nm more preferred and about 400 to about 750 nm even more preferred.

The light-conducting component 91 may be structure that permits light to reach the phosphorescent material 14 such as any existing window 93, including a windshield 95, of the vehicle. The window 93 may be of any of a variety of shapes including circular or rectangular. The window 93 may be made of glass, plastic or a combination thereof. Typically, glass transmits light within the blue part of the visible spectrum, i.e., light having wavelengths of about 350 to about 450 nm.

As shown in this view, radiant energy from an external light source shines onto a light-conducting component 91. As the light passes through the light-conducting component 91, a portion of the light passes directly into the interior portion 30 of the vehicle such as a passenger compartment 99 and is absorbed by the phosphorescent material 14 of the interior panel 10. The phosphorescent material 14 of the interior panel 10 is excited by the radiant energy and slowly decays, causing the phosphorescent material 14 to glow for a period of time following exposure to the and absorption of the radiant energy. In addition, the phosphorescent material 14 may scatter the radiant energy entering the interior panel 10 thereby diffusing the light that enters into the interior 30 of the vehicle 100.

Advantageously, a phosphorescent interior panel provides a light emitting medium that may provide light into a vehicle without the use of additional power or increasing the heat load within the vehicle. A phosphorescent material containing phosphors of varying decay time may be excited by incident light emanating from an external light source, causing the phosphors to glow and provide enhanced visibility and a spacious sensation and/or appearance within the vehicle while maintaining privacy of the passengers within the vehicle. Further, the glow within the vehicle may provide safety and emergency lighting when vehicle power is unavailable. The time period of the glow light discharge may provide a secondary light source in the absence of an external light source, such as at night.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

1. An interior panel for a vehicle, said panel comprising:
a phosphorescent material; and
a polymer matrix.

2. The interior panel as in claim 1, wherein the phosphorescent material is dispersed within the polymer matrix.

3. The interior panel as in claim 1, wherein the phosphorescent material is disposed on at least one surface of the polymer matrix.

4. The interior panel according to claim 1, wherein the phosphorescent material comprises a non-oxide phosphor, an oxide phosphor, or a combination comprising at least one of the foregoing phosphors.

5. The interior panel according to claim 4, wherein the non-oxide phosphor is selected from a group consisting of zinc sulfide, zinc sulfide doped with a transition metal, and zinc sulfide doped with a rare earth metal.

6. The interior panel according to claim 4, wherein the oxide phosphor is selected from a group consisting of an oxide ceramic phosphor, an oxide ceramic phosphor doped with an alkaline earth metal, and an oxide ceramic phosphor doped with a rare earth metal.

7. The interior panel according to claim 1, wherein the phosphorescent material comprises an alkaline-earth metal oxide aluminate.

8. The interior panel according to claim 1, wherein the phosphorescent material forms a pattern on or in the polymer matrix.

9. The interior panel according to claim 1, further comprising:
a light transparent material.

10. The interior panel according to claim 9, wherein the light transparent material transmits light having wavelengths of about 200 to about 800 nm.

11. A vehicle roof assembly, comprising:
a roof wall extending between an interior portion and an exterior portion of a vehicle; and
an interior panel comprised of a phosphorescent material and a polymer matrix, the interior panel disposed on an interior surface of the roof wall.

12. The assembly according to claim I 1, wherein the phosphorescent material is dispersed within the polymer matrix.

13. The assembly according to claim 11, wherein the phosphorescent material is disposed on at least one surface of the polymer matrix.

14. The assembly according to claim 11, wherein the phosphorescent material comprises a non-oxide phosphor, an oxide phosphor, or a combination comprising at least one of the foregoing phosphors.

15. The assembly according to claim 11, wherein the non-oxide phosphor is selected from a group consisting of zinc sulfide, zinc sulfide doped with a transition metal, and zinc sulfide doped with a rare earth metal.

16. The assembly according to claim 11 further comprising:
a light-conducting component disposed between a location external to the vehicle and a point adjacent to the interior panel to transmit external light to the interior panel for exciting the phosphorescent material to glow for a period of time following exposure to the external light.

17. The assembly according to claim 11, wherein the light-conducting component comprises an existing window of the vehicle.

18. A method for providing a light source in a vehicle, wherein the light source is free of an external power supply, the method comprising:
exposing a panel disposed on an interior surface of a wall of a vehicle to an external light source, wherein the panel comprises a phosphorescent material and a polymer matrix; and
emitting visible light from the phosphorescent material and into the interior portion of the vehicle upon exposure to the external light source or upon discontinuation of the external light source.

19. The method according to claim 18, further comprising diffusing the radiant energy produced from the external light source with the phosphorescent material.

20. The method of claim 18, wherein the wall comprises a roof wall.
